(19) United States
(12) Patent Application Publication
(10) Pub. No.: US 2013/0071593 A1
(43) Pub. Date: Mar. 21, 2013

(54) INSULATING MEMBER FOR COVERING A CONDUIT IN A CLEAN ROOM

(71) Applicants: Ronald MacNeill, Kingston, NH (US); Tuna Sava, Newburyport, MA (US); Michael Joseph King, Topsfield, MA (US)

(72) Inventors: Ronald MacNeill, Kingston, NH (US); Tuna Sava, Newburyport, MA (US); Michael Joseph King, Topsfield, MA (US)

(21) Appl. No.: 13/617,501

(22) Filed: Sep. 14, 2012

Related U.S. Application Data
(60) Provisional application No. 61/535,914, filed on Sep. 16, 2011.
(60) Provisional application No. 61/647,216, filed on May 15, 2012.

(51) Int. Cl. B32B 27/06; B32B 27/08; F16L 59/02

(52) U.S. Cl. 428/36.5

(57) ABSTRACT

This disclosure provides an insulating member for covering a conduit in a clean room. The insulating member typically has a length and defines a cavity extending along the length. The cavity is sized and shaped to receive the conduit. The insulating member typically includes an innermost layer that may be a closed cell fluoropolymer foam and is disposed to contact the conduit. The insulating member also typically includes an outermost layer that is disposed on the innermost layer and that may be a second fluoropolymer.

### CROSS-REFERENCE TO RELATED APPLICATIONS

The subject patent application claims priority to and all the benefits of U.S. Provisional Patent Application Nos. 61/535,914 filed on Sep. 16, 2011, and 61/647,216 filed on May 15, 2012, each of which is expressly incorporated herein by reference in its entirety.

### FIELD OF THE DISCLOSURE

The subject disclosure generally relates to an insulating member for covering a conduit in a clean room. More specifically, the subject disclosure relates to an insulating member that typically includes a fluoropolymer foam.

### BACKGROUND OF THE DISCLOSURE

Clean rooms are controlled environments in which air quality is closely monitored for particle content. Many clean rooms include equipment, such as pipes, that are chilled or heated. The process of insulating clean rooms and the equipment therein (e.g. with insulating members) can be difficult because many traditional insulation materials tend to disintegrate easily and contaminate the clean rooms with dust and particulates. For example, many types of insulation materials must be cut to size outside of clean rooms to minimize any dust generation. This increases installation costs, time, and complexity. In addition, many types of insulation materials are bulky, thereby requiring additional space to be added to clean rooms or causing potential hazards due to lack of space. In addition, the bulk of these insulation materials increases costs. Moreover, many types of insulation materials cannot withstand low or high temperatures, temperature fluctuations, or harsh cleaning/disinfecting products that are used to maintain the clean rooms and may support mold growth. Accordingly, there remains an opportunity to develop improved insulation materials.

### SUMMARY OF THE DISCLOSURE AND ADVANTAGES

In one embodiment, this disclosure provides an insulating member for covering a conduit in a clean room. The insulating member has a length and defines a cavity extending along the length, wherein the cavity is sized and shaped to receive the conduit. The insulating member includes an innermost layer that is a closed cell fluoropolymer foam and is disposed to contact the conduit. The insulating member also includes an outermost layer that is disposed on the innermost layer and that is a second fluoropolymer.

The insulating member of this disclosure, e.g. when utilized in clean room, typically exhibits a high R-value relative to a typical thickness which allows for less material to be used. This not only reduces bulk but also reduces cost. The insulating member also can typically be cut to fit the conduit while in the clean room, e.g. without the use of tents or bags, because the insulating member tends to resist fragmentation and typically produces minimal (if any) dust when cut. This reduces processing complexities, reduces installation time, and reduces overall cost in addition to reducing potential contamination in the clean rooms. Moreover, the insulating member typically can withstand both hot and cold temperatures without failure, resists mold growth, and typically resists degradation and failure when exposed to cleaning and disinfecting products. Furthermore, the insulating member typically produces minimal smoke if burned. This reduces hazards and potential further contamination in case of fire.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a perspective end view of an insulating member including an innermost layer and an outermost layer disposed on and in direct contact with the innermost layer;

FIG. 2 is a perspective view of an insulating member including an innermost layer and an outermost layer disposed on and in direct contact with the innermost layer;

FIG. 3 is a perspective view of an insulating member including an innermost layer, an outermost layer, and an adhesive sandwiched between the innermost layer and the outermost layer and disposed on and in direct contact with both the innermost layer and the outermost layer simultaneously;

FIG. 4 is a cross-sectional end view illustrating a protective film (e.g. an outermost layer) being applied to a foam (e.g. an innermost layer) to form an insulating member via a lamination process utilizing a heated roller and a pinch roller;

FIG. 5 is a perspective view of a variety of different insulating members and a variety of different insulating members disposed about a plurality of conduits;

FIG. 6 is a perspective view of a variety of insulating members and an insulating member disposed about a conduit;

FIG. 7 is another perspective view of a variety of insulating members and a variety of insulating members disposed about a plurality of conduits;

FIG. 8 is a perspective view of a insulating member shaped as a clam-shell in an open position disposed about a conduit;

FIG. 9 is a perspective view of a insulating member shaped as a clam-shell rotated towards a closed position and disposed about a conduit;

FIG. 10 is an environmental view illustrating a plurality of insulating members disposed about a plurality of conduits in a clean room;

FIG. 11 is another environmental view illustrating a plurality of insulating members disposed about a plurality of conduits in a clean room;

FIG. 12 is still another environmental view illustrating a plurality of insulating members disposed about a plurality of conduits in a clean room; and

FIG. 13 is yet another environmental view a plurality of insulating members disposed about a plurality of conduits in a clean room.

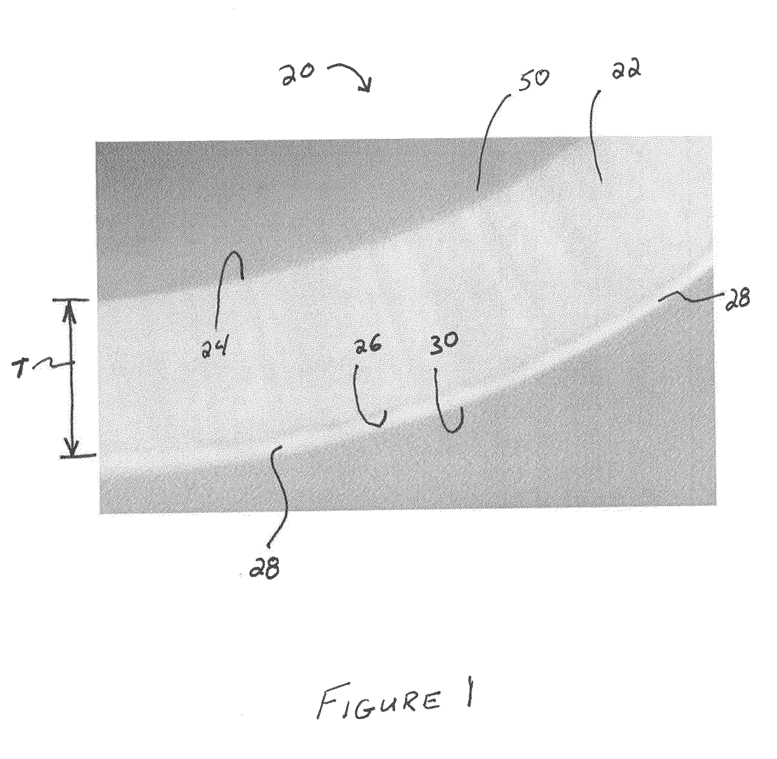

### DETAILED DESCRIPTION OF THE DISCLOSURE

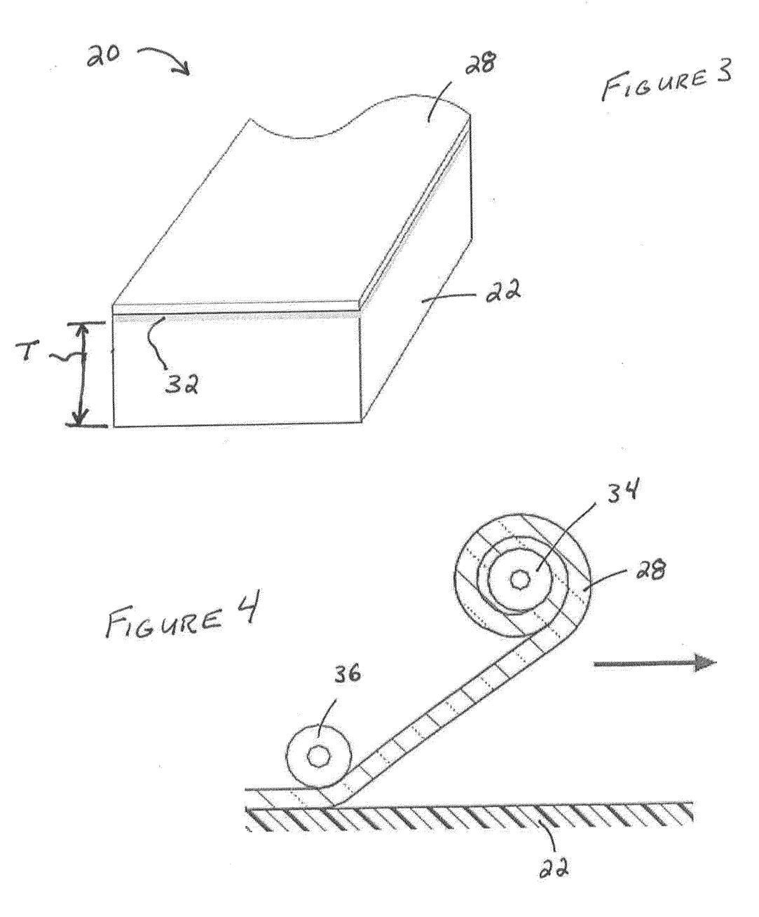

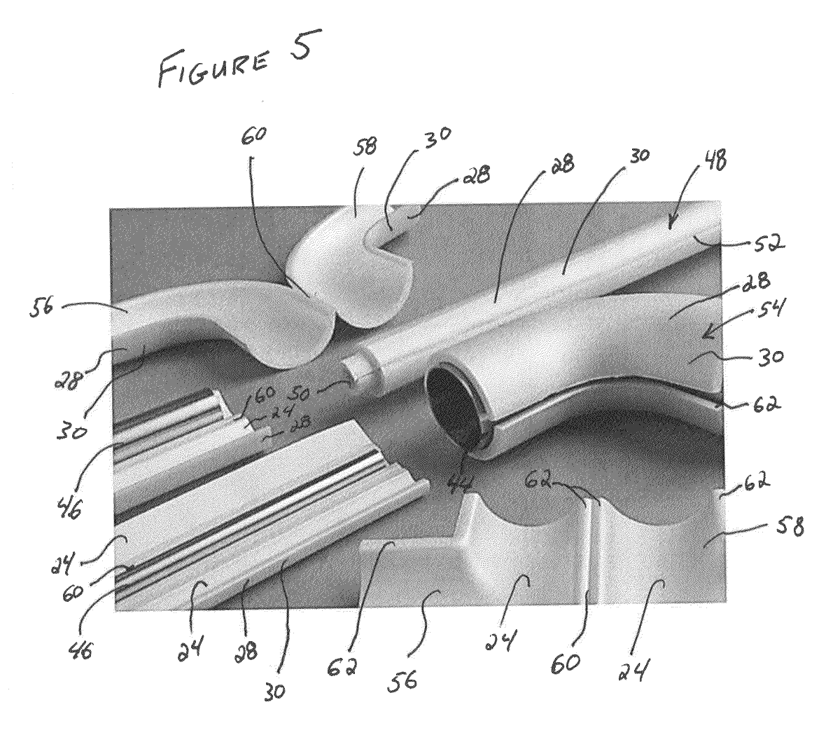

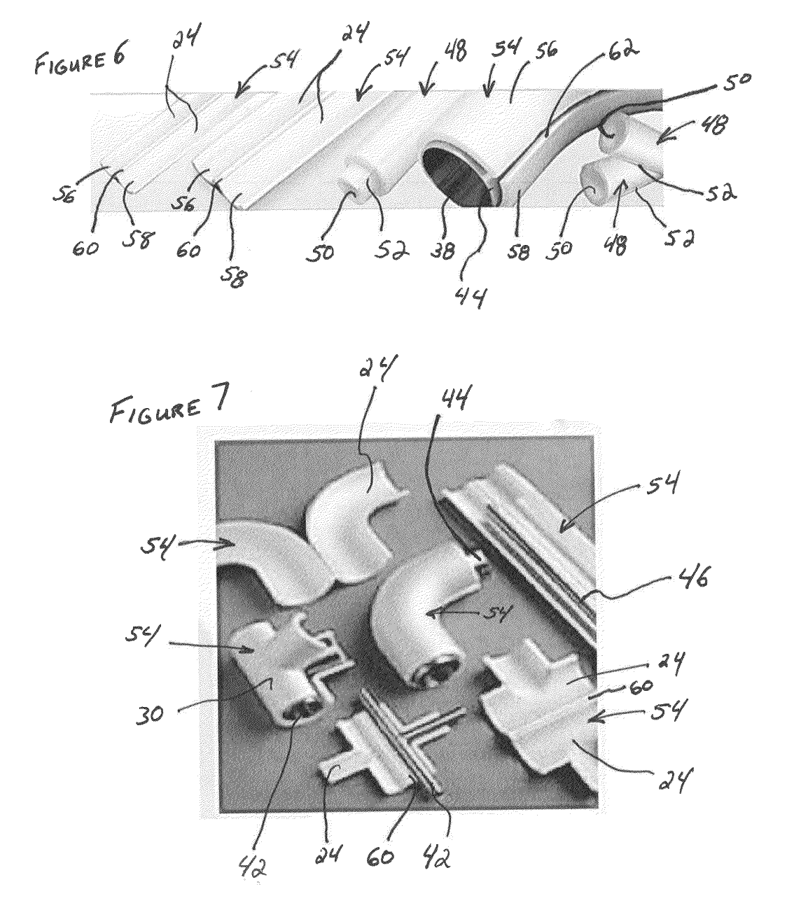

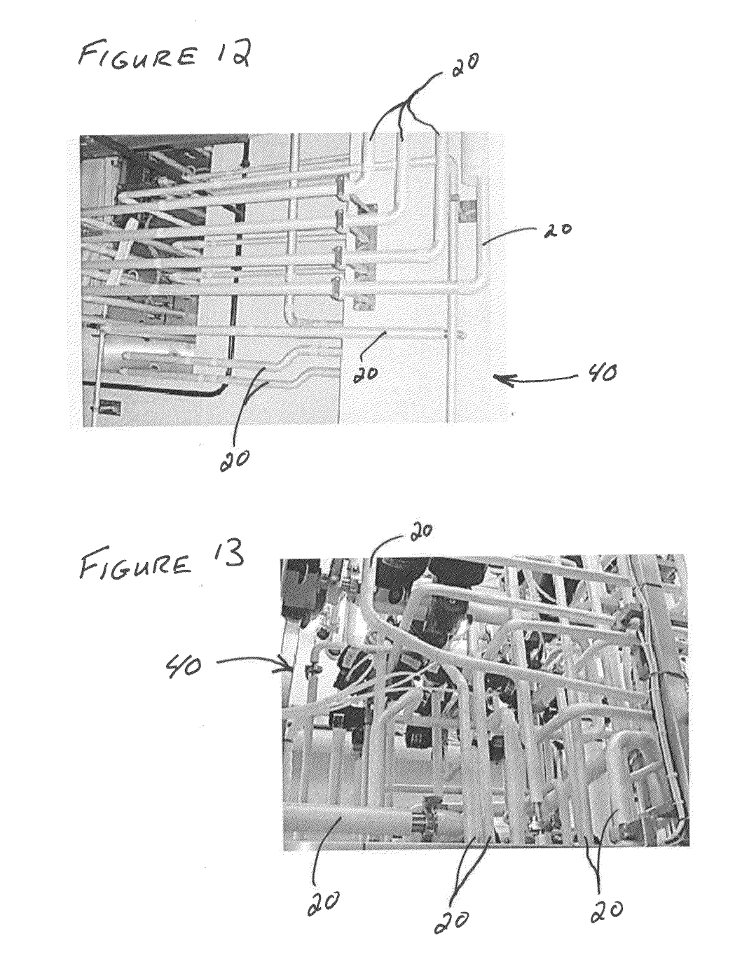

With reference to the Figures, wherein like numerals indicate like or corresponding parts throughout the several views, an insulating member is generally shown at (20). In one embodiment, the insulating member (20) can be used to partially or completely cover (or be disposed about) all or a portion of a conduit (38), e.g. in FIGS. 5-13. The insulating member (20) may be utilized in clean room or may be utilized for an entirely different purpose or in an entirely different setting. The insulating member (20) is not limited to any particular insulating value or efficiency and may insulate from high and/or low temperatures, e.g. from ambient temperature to about −40° C., from ambient temperature to about 160° C. or, for example, from about 112° F. to about 450° F. All sub-ranges of temperatures within the aforementioned ranges are also hereby expressly contemplated as non-limiting embodiments of this disclosure.

The terminology “conduit” is not particularly limiting and may include, or be further defined as, a passage, pipe, cable, channel, duct, pipeline, spout, tube, or line, and may direct fluids. The insulating member (20) and/or the conduit (38) is not limited relative to shape and/or size. The conduit (38) may be tubular in shape or may be a T-joint (42), an elbow (44), a coupling (not shown in the Figures), or a (substantially straight) tube (46). The elbow (44) typically includes a 90° bend or a 45° bend. However, the elbow (44) may include any other angular bend. The conduit (38) may define any length and any diameter. The conduit (38) may be further defined as a plurality of conduits (38) which may be interconnected by the T-joint (42), elbow (44), and/or coupling. The conduit (38) may be, include, consist essentially of, or consist of, stainless steel, copper, aluminum, iron, PVDF, polypropylene, or any other suitable material. The material of the conduit (38) may be dependent on the application for which the conduit (38) is utilized. Each of the tube (46), the T-joint (42), the elbow (44), and the coupling all may be independently formed from the same material or a different material.

In various embodiments, the conduit (38) is, includes, consists essentially of, or consists of, aluminum or polypropylene, while the T-joint (42) and elbow (44) each independently is, includes, consists essentially of, or consists of, copper or stainless steel. The terminology “consists essentially of” describes that the conduit (38) may include one or more of the aforementioned materials and be free of one or more of the other aforementioned materials.

The insulating member (20) may have a length and define a cavity (50) extending along the length. The cavity (50) may be defined complementary to a size and shape of the conduit (38) or may be different from the size and shape of the conduit (38). Alternatively, the cavity (50) may be sized and shaped to receive the conduit (38). The insulating member (20) may also include an innermost layer (22) that is disposed to contact the conduit (38). The insulating member (20) may also include an outermost layer (28) that is disposed on the innermost layer (22). The outermost layer (28) may be disposed on and in direct contact with the innermost layer (22) or disposed on, and spaced apart from, the innermost layer (22) (e.g. separated from the innermost layer (22) by one or more adhesives (32) or tie layers). One suitable adhesive (32) is generally known in the art as polyurethane (PUR) Hotmelt. However, any other adhesive (32) may be utilized without deviating from the subject disclosure. In one embodiment, the outermost layer (28) is disposed on and in direct contact with the innermost layer (22) and the insulating member is free of any adhesive or tie layer disposed between the innermost layer (22) and the outermost layer (28). In various embodiments, the insulating member (20) has, includes, consists essentially of, or consists of, the innermost layer (22) and the outermost layer (28). The terminology “consists essentially of” in this embodiment describes that the insulating member (20) is free of additional foam or polymer layers. It is contemplated that the insulating member (20) may consist essentially of the innermost layer (22) and the outermost layer (28) and either include, or be free of, one or more adhesive and/or tie layers.

### Innermost Layer:

The innermost layer (22) may be, include, consist essentially of, or consist of, a foam. Similarly, the foam itself may be, include, consist essentially of, or consist of, an organic foam (e.g. a polyurethane) or a fluoropolymer foam. The foam may be a closed cell fluoropolymer. The terminology “consist essentially of” describes that the innermost layer (22) and/or the foam is free of resins (i.e., non-foamed compounds). In another embodiment, the foam is a fluorinated or halogenated polymer foam. For example, the foam may consist essentially of a fluoropolymer foam and be free of organic (non-fluorinated) foams, and vice versa.

In other embodiments, the innermost layer (22) and/or the foam is, includes, consists essentially of, or consists of, a polymer. The polymer may be a thermoplastic or thermoset polymer. In one embodiment, the polymer is a fluoropolymer, e.g. polyvinylidene fluoride (PVDF). In other embodiments, the polymer may be, include, consist essentially of, or consist of polyvinylidene fluoride (PVDF), polyethylene, nylon, polypropylene, or other high-temperature and high-chemical resistant materials. The terminology “consist essentially of” describes that the polymer may be free of co-polymers or mixtures of different polymers.

The innermost layer (22) and/or the foam may also include cross-linked materials. However, non cross-linked materials may also be utilized. A suitable example of a closed cell PVDF foam is commercially available under the trade name ZOTEK® F from Zotefoams of Croydon, Greater England, UK. Another suitable example of a closed cell PVDF foam is commercially available under the trade name Sold® 80 000 Series Expanded PVDF from Solvay Solexis, Inc. of Thorofare, N.J. A suitable example of a nylon foam is commercially available under the trade name ZOTEK® N from Zotefoams of Croydon, Greater England, UK.

ZOTEK® F is typically formed from a PVDF fluoropolymer. A suitable PVDF fluoropolymer is commercially available under the trade name Kynar® from ARKEMA Inc. of King of Prussia, Pa. Kynar® has excellent physical properties, such as resistance to aging, ultraviolet (UV), and nuclear radiation. Additionally Kynar® demonstrates high dielectric strength and outstanding resistance to a wide range of solvents and aggressive chemicals. Kynar® is biologically inert and has a very low order of toxicity. Further, Kynar® is thermally stable across a wide range of temperatures and is inherently flame retardant. During combustion, Kynar® releases very little heat and smoke. Additional suitable PVDF fluoropolymers are commercially available under the trade names Solef® and Hylar® from Solvay Solexis, Inc. of Thorofare, N.J. The aforementioned physical properties may be present in any innermost layer (22) and/or foam of this disclosure. For example, the insulating member (20) may exhibit a smoke rating of 25/50 when measured according to ASTM E84 Smoke/Flame Testing procedures.

The foam and/or the innermost layer (22) of the insulating member (20), may itself have a first (e.g. inner) surface (24) and a second (e.g. outer) surface (26) spaced from the first surface (24) of the foam. A thickness T, of the innermost layer (22) and/or the foam, may be defined between the first and second surfaces (24, 26) of the innermost layer (22) and/or the foam. The thickness T helps contributes to an insulating value of the insulating member (20). The insulating value is commonly described as an R-value. Generally, a greater thickness T correlates to a higher R-value. The higher R-value allows the insulating member (20) to have a greater insulating value than a similar insulating member having a lesser thickness T. The thickness T is typically from about 0.06 inches to about 4.0 inches, from about 0.12 inches to about 3.0 inches, or from about 0.25 inches to about 2.0 inches. All sub-ranges of thicknesses within the aforementioned ranges are also hereby expressly contemplated as non-limiting embodiments of this disclosure.

The foam and/or the innermost layer (22) may be manipulated using conventional foam conversion methods. The conversion methods may include, but are not limited to, die-cutting, sawing, water-jet cutting, laser cutting, laminating, welding into continuous rolls, or any other appropriate method. Additionally, the foam and/or the innermost layer (22) may be thermoformed into complex single component structures which provide benefits over a multilayered structure, such as, but not limited to weight and cost reductions. The foam and/or the innermost layer (22) may include other materials without deviating from the subject disclosure.

### Outermost Layer:

The outermost layer (28) may be included in the insulating member (20) or may be absent. If absent, the insulating member (20) is typically a single layer foam. The outermost layer (28) may be alternatively described as a film or coating that may be disposed on the innermost layer (22). In this embodiment, the insulating member (20) may be further defined as a bi-layer insulating member (20). The outermost layer (28) may be coupled to the foam or the innermost layer (22) and itself be further described as a show surface (30) of the insulating member (20). The outermost layer (28) is typically disposed on the innermost layer (22), e.g. on the second surface of the innermost layer (22).

The outermost layer (28) typically is, includes, consists essentially of, or consists of a nonporous material. The terminology “consists essentially of” describes that the outermost layer (28) may be free of materials, such as polymers, that are porous. More typically, the outermost layer (28) is, includes, consists essentially of, or consists of a thermoplastic polymer, e.g. chemically similar to the innermost layer (22). In various embodiments, the outermost layer (28) may be, include, consist essentially of, or consist of a fluoropolymer. In other embodiments, the outermost layer (28) may be, include, consist essentially of, or consist of PVDF, polyethylene, polypropylene, or nylon or combinations thereof. In certain embodiments, the outermost layer (28) may be, include, consist essentially of, or consist of nonporous PVDF. The outermost layer (28) and the innermost layer (22) may each independently be, include, consist essentially of, or consist of the same polymers or different polymers relative to chemistry and/or physical form. For example, the outermost layer (28) and the innermost layer (22) may each independently be, include, consist essentially of, or consist of one or more fluoropolymers such that the innermost and outermost layers (22, 28) are both foams or both resins or one or each. The outermost layer (28) may be further defined as a skin, a jacket, or a protective layer, (e.g. a resin) which is disposed on the innermost layer (22) which may be a foam.

The outermost layer (28) tends to protect the innermost layer (22) from deterioration caused by exposure to the environment and the outermost layer (28) may help to hold the innermost layer (22) together. The outermost layer (28) typically has a thickness of from about 0.001 inches to about 0.100 inches, from about 0.002 inches to about 0.060 inches, or from about 0.003 inches to about 0.040 inches. However, the thickness of the outermost layer (28) may be less than 0.001 inches and/or greater than 0.100 inches without deviating from the scope of the present disclosure. All sub-ranges of thicknesses within the aforementioned ranges are also hereby expressly contemplated as non-limiting embodiments of this disclosure.

The outermost layer (28) typically provides a non-porous surface that can be easily cleaned when the insulating member (20) is installed about the conduit (38). More specifically, the outermost layer (28) typically provides excellent moisture resistance and inhibits mold growth. When the insulating member (20) is installed, e.g. in a clean room (40), the outermost layer (28) typically provides a layer that is impervious or resistant to solvent cleaning and low pressure water wash downs. In this embodiment, there tends to be no need to remove the insulating member (20) from the conduit (38) to clean the conduit (38). The outermost layer (28) of the insulating member (20) is typically both puncture and abrasion resistant providing additional protection to the conduit (38) while protecting the innermost layer (22) from deterioration. Additionally, the insulating member (20) typically resists cracking and caving. In other words if the insulating member (20) is struck or bumped, it tends to rebound such that dents typically do not remain therein.

The innermost layer (22) and/or the outermost layer (28) may each independently include a colorant. For example, a blue colorant may be add to the innermost layer (22) and/or the outermost layer (28) to designate a cold line and a red colorant may be added to the innermost layer (22) and/or the outermost layer (28) to designate a hot line. The colorant may be a pigment, a dye, a tint, a stain, etc. The colorant is not limited and may be any color that is desired. The colorant may be added to the innermost layer (22) and/or the outermost layer (28) merely to make the insulating member (20) more aesthetically pleasing.

The outermost layer (28) may be coupled to the innermost layer (22) utilizing any suitable process. Some suitable processes include, but are not limited to, extrusion, adhesion, adhesive lamination, and hot roll lamination. Alternative methods for coupling the outermost layer (28) and innermost layer (22) to one another may also be employed without deviating from the scope of the present disclosure.

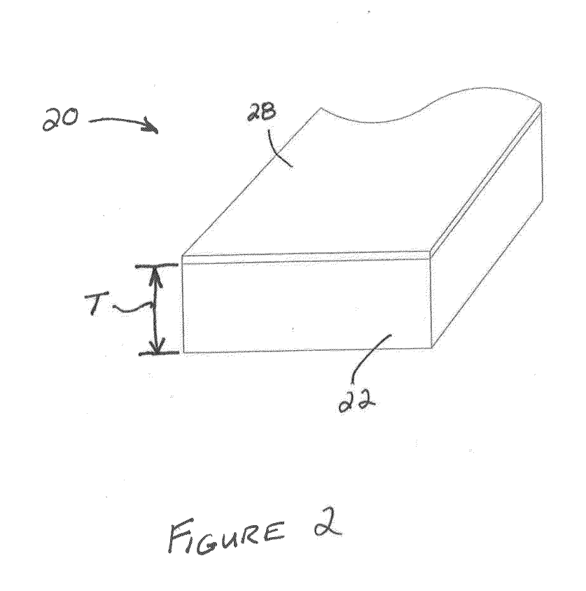

In one embodiment, e.g. as shown in FIG. 2, the outermost layer (28) may be extruded onto the innermost layer (22). The outermost layer (28) may exit an extrusion machine at a predetermined temperature and be introduced to the innermost layer (22). The predetermined temperature for PVDF is typically of from about 300° F. to about 600° F., from about 350° F. to about 500° F., or from about 400° F. to about 450° F. The predetermined temperature for the nylon is typically of from about 200° F. to about 800° F., from about 300° F. to about 700° F., or from about 350° F. to about 650° F. All sub-ranges of temperatures within the aforementioned ranges are also hereby expressly contemplated as non-limiting embodiments of this disclosure.

The outermost layer (28) is typically in a molten state when the outermost layer (28) is introduced to the innermost layer (22) such that the outermost layer (28) has a low viscosity. In this embodiment, after the outermost layer (28) is introduced to the innermost layer (22), the innermost layer (22) and the outermost layer (28) typically pass through a plurality of pinch rollers (36), as set forth in FIG. 4. The pinch rollers (36) typically force the molten outermost layer (28) into the innermost layer (22). More specifically, the innermost layer (22) tends to be porous, such that the innermost layer (22) may define a plurality of pores therein. The molten outermost layer (28) may be forced into the pores of the innermost layer (22) by the pinch rollers (36). As the outermost layer (28) cools, a bond may be formed between the outermost layer (28) and the innermost layer (22).

The outermost layer (28) may be coupled to the innermost layer (22) through adhesive lamination, e.g. as shown in FIG. 3. In this embodiment, an adhesive (32) or tie layer (e.g. a bonding agent) may be disposed between, or sandwiched between, the outermost layer (28) and the innermost layer (22) and may be in direct contact with each simultaneously. Alternatively, one or more independent tie layers or layers of adhesives, which may be the same or different from each other, may be used. The tie layer(s) are not particularly limited and may be polyurethane or any other known in the art.

The adhesive (32) may be applied to one of the surfaces of the innermost layer (22), typically the second surface (26) such that the adhesive (32) may substantially cover the second surface (26). The outermost layer (28) may be then introduced to the innermost layer (22), e.g. to the second surface (26) of the innermost layer (22), such that the outermost layer (28) is adhesively bonded to the innermost layer (22). Alternatively, the adhesive (32) may be applied to the outermost layer (28) prior to introducing the outermost layer (28) to the innermost layer (22). In yet another alternative, the adhesive (32) may be applied to both the outermost layer (28) and the innermost layer (22) prior to introducing the outermost layer (28) and the innermost layer (22) to one another.

In another embodiment, e.g. as shown in FIG. 4, a hot roll lamination process may be employed to couple the outermost layer (28) and the innermost layer (22). The hot roll lamination process typically utilizes a pre-extruded outermost layer (28). In other words, the outermost layer (28) may be extruded in a separate process prior to the hot roll lamination process. The pre-extruded outermost layer (28) may be disposed on a heated roller (34) for heating the outermost layer (28) to a predetermined temperature. The predetermined temperature is typically of from about 200° F. to about 600° F., from about 300° F. to about 500° F., or from about 350° F. to about 450° F. All sub-ranges of temperatures within the aforementioned ranges are also hereby expressly contemplated as non-limiting embodiments of this disclosure.

When the pre-extruded outermost layer (28) reaches the predetermined temperature, the outermost layer (28) may be introduced to the innermost layer (22). As the outermost layer (28) is introduced to the innermost layer (22), the combination may be compressed together by a plurality of pinch rollers (36) for forcing the outermost layer (28) and the innermost layer (22) together. As the outermost layer (28) cools, a bond may be formed between the outermost layer (28) and the innermost layer (22). Additionally, the adhesive (32) may also be introduced between the outermost layer (28) and the innermost layer (22) for enhancing the bond therebetween.

The insulating member (20) may be further defined as a wrap (48) for covering the conduit (38). The insulating member (20) itself and/or the wrap (48) may present a generally cylindrical configuration and define a cavity (50) along a length of the insulating member (20). The cavity (50) may define a configuration that may be complementary to the shape and size of the conduit (38). The insulating member (20) may also include a slit (52) along the length, e.g. substantially parallel to the cavity (50), for inserting the conduit (38) therethrough and into the cavity (50).

The wrap (48) may also include the first surface and the second surface spaced from the first surface, thereby defining a thickness of the wrap (48), e.g. as similarly described above relative to the thickness T. It should be appreciated that the wrap (48) may define any appropriate thickness and width. Said differently, the width and the thickness of the wrap (48) is not particularly limited. In this embodiment, the wrap (48) may be wound around the conduit (38) for enclosing the conduit (38) within the wrap (48). A first surface of the wrap (48) may be in contact with the conduit (38) and a second surface may be exposed to the environment. An adhesive (32) may be disposed on substantially the entire first surface of the wrap (48) for coupling the wrap (48) to the conduit (38). Alternatively, the adhesive (32) may be applied to only a portion of the wrap (48) for coupling the wrap (48) to itself when the wrap (48) is wound around the conduit (38).

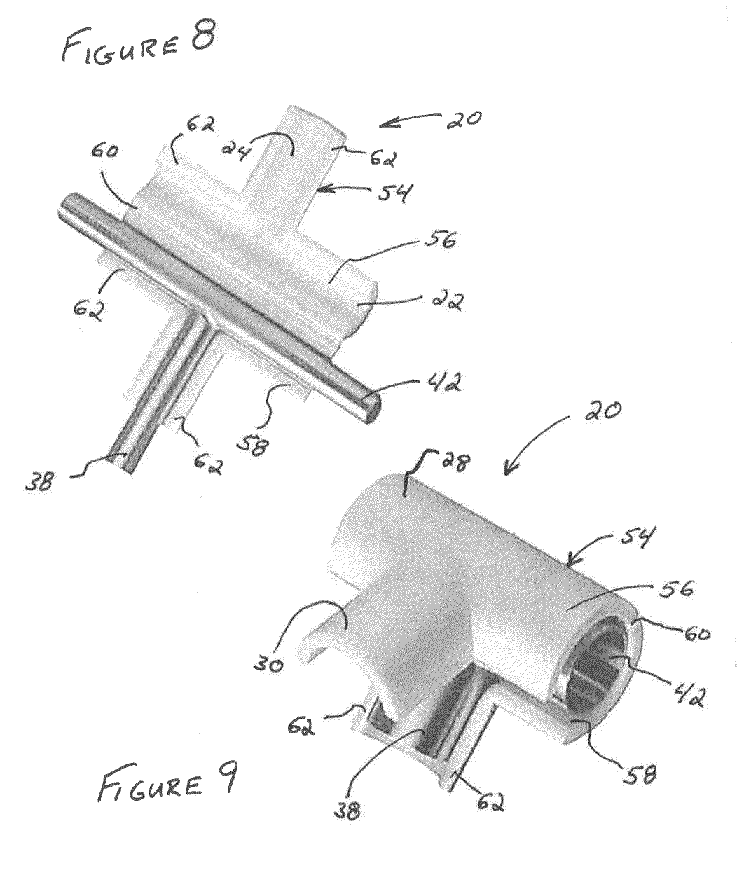

With additional reference to FIGS. 8 and 9, the insulating member (20) may define a clam-shell (54). The clam-shell (54) may have or be a first portion (56) and a second portion (58) movably coupled to the first portion (56). A hinge (or hinge portion) (60) may couple the first portion (56) to the second portion (58) for allowing movement of the first and second portions (56, 58) relative to one another between an open position, as shown in FIG. 8, and toward a closed position, as shown in FIG. 9. An edge (62) may be exposed about a perimeter when the first and second portions (56, 58) of the clam-shell are separated from one another. An edge (62) of the first portion (56) may abut an edge (62) of the second portion (58) when the clam-shell (54) is in the closed position. When installing the clam-shell (54), the first portion (56) may be rotated away from the second portion (58) about the hinge (60) to the open position, e.g. for exposing a surface, as shown in FIG. 8. The conduit (38), here the T-joint (42), may be placed in contact with a surface of the second portion (58) or the innermost layer (22). The first portion (56) may then be rotated toward the second portion (58) about the hinge (60) for enclosing the conduit (38) within the insulating member (20), as illustrated in FIG. 9. An adhesive (32) (not shown) may be disposed on at least a portion of the edge (62) for coupling the first and second portions (56, 58) to one another.

A protective layer also may be disposed over the adhesive (32) for protecting the adhesive (32) prior to installation of the insulating member (20) about the conduit (38). Alternatively, a tape also may be applied over the surface and/or the outermost layer (28), e.g. for securing the first and second portions (56, 58) in the closed position. The tape may also be placed over the slit (52) of the wrap (48) for sealing the wrap (48) about the conduit (38). In still another embodiment, one of the first or second portions (56, 58) may be extended to include a lengthened portion (not shown) such that the lengthened portion overlaps the other of the first or second portions (56, 58). The adhesive (32) may be placed on the surface of the lengthened portion such that the adhesive (32) will bond the lengthened portion to the second surface of the first or second portions (56, 58). The insulating member (20) may also be configured to cover a (straight) tube (46) or elbow (44).

The tape may also be utilized to seal the insulating member (20). The tape may be further defined as a pressure sensitive tape. Typically, the tape includes a PVDF layer on the outside with a pressure sensitive adhesive disposed thereon. More specifically, the pressure sensitive adhesive of the tape may be further defined as a high-performance and high-temperature adhesive. In certain embodiments, a high-performance duct tape may be utilized. Typically, the high-performance duct tape is used when the innermost layer (22) includes nylon. The tape typically includes an adhesive and a liner for covering the adhesive disposed thereon until the tape is to be installed.

The pressure sensitive tape may include a material that is the same or different from the insulating member (20). More specifically, the tape typically includes a material that is the same or similar to the outermost layer (28) of the insulating member (20) such that the tape will blend with the outermost layer (28). The colorant may also be added to the tape, e.g. if the colorant is added to the innermost layer (22) and/or the outermost layer (28). The tape blending with the insulating member (20) may be preferable because the insulating member (20) tends to be more aesthetically pleasing and not have a patch-work pattern on the outermost layer (28) of the insulating member (20). However, the tape may be any other color or material without deviating from the scope of the present disclosure. The tape may be applied to the insulating member (20) prior to installing the insulating member (20) on to the conduit (38). Alternatively, the tape may be applied after the insulating member (20) is installed on to the conduit (38).

The tape may also be utilized for coupling adjacent insulating members (20) to one another. The adjacent insulating members (20) may include, but are not limited to, a plurality of insulating members (20) configured to cover tubes (46), couplings, elbows (44), and/or T-joints (42). For example, the tape may also be used to couple the insulating member (20) and/or the wrap (48) to itself as it is wound around the conduit (38).

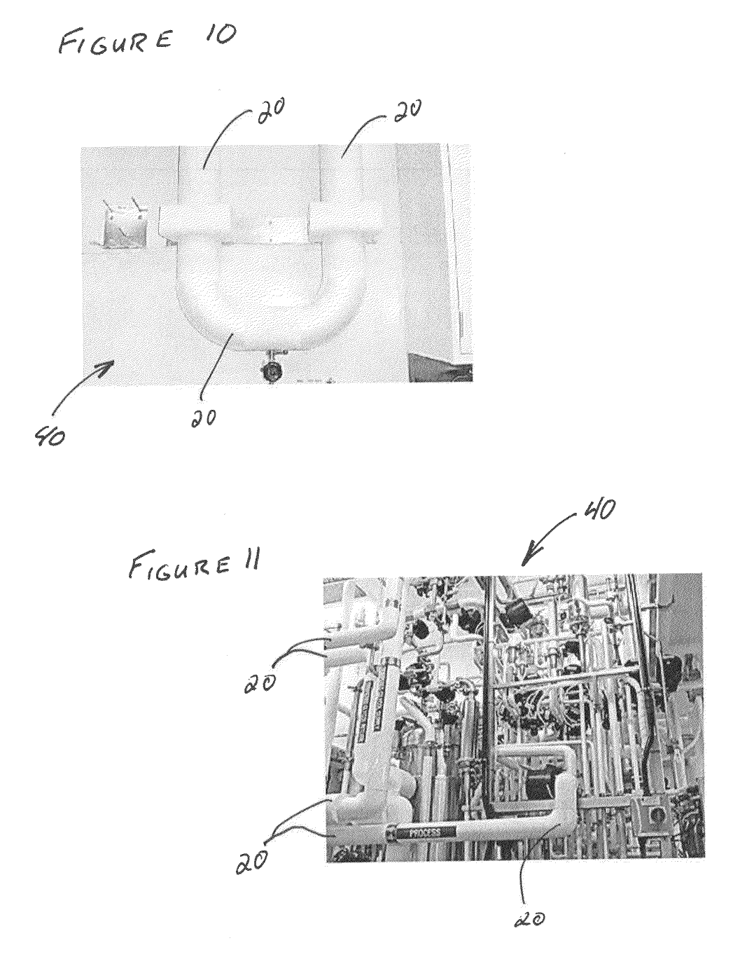

The insulating member (20) may be used to cover conduit (38) located in a clean room (40), as shown in FIGS. 10-13. The clean room (40) may be a controlled environment, e.g. used in electronics or vaccine production. Typically, clean rooms (40) require monitoring for particle content to ensure suitable air quality therein. The insulating member (20) may protect persons who may contact the conduit (38). For example, certain safety standards, typically directed by the Occupational Safety and Health Administration (OSHA), typically require that any contact surface within the clean room (40) can not exceed 140° F. The insulating member (20) typically helps ensure that this standard is satisfied, even when the fluid within the conduit (38) reaches temperatures in excess of 450° F. Additionally, the insulating member (20) may help minimize condensation from forming on conduit (38) for cold materials. Condensation may further contaminate the clean room (40) and therefore is typically minimized. The insulating member (20) may allow the conduit (38), specifically the fluid or material within the conduit (38), to remain at a substantially constant temperature. Alternatively, the thickness T of the innermost layer (22), may be varied along the conduit (38), thereby varying the insulative value of the insulating member (20), e.g. if a temperature variation of the fluid or material is desired as the fluid or material travels along the conduit (38).

The insulating member (20) may be cut to size and installed within the clean room (40). The insulating member (20) tends to not create particulates or at least minimizes the amount of particulates created, when cut or installed. Additionally, the insulating member (20) tends to not produce out-gases. Both the particulates and the out-gases may contaminate the clean room (40), and may be minimized or eliminated. Installation of the insulating member (20) tends to be efficient when the outermost layer (28) is preinstalled on the innermost layer (22) such that the insulating member (20) merely needs to be cut to the desired size.

In one embodiment, the innermost layer (22) is a ZOTEK F Kynar PVDF foam core covered with a non-porous PVDF film as the outermost layer (28). Moreover, in this embodiment, a PVDF pressure sensitive tape is used to seal and retain the insulating member (20) on the conduit (38). Typically in this embodiment, an exposed section of the tape has a liner which is peeled off during application of the insulating member (20) to the conduit (38). Furthermore, in this embodiment, the tape is typically applied to tees and elboews. The tape and the PVDF cover, in this embodiment, are the same material to maximize changes of a color match and to reduce any patchwork appearance of the insulating member (20).

In one or more non-limiting embodiments, this disclosure may also include one or more elements, compounds, method steps, configurations, etc. described in one or both of U.S. Provisional Patent Application Nos. 61/535,914 filed on Sep. 16, 2011, and 61/647,216 filed on May 15, 2012, each of which is expressly incorporated by reference in its entirety relative to the one or more non-limiting embodiments.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, is herein expressly contemplated. The disclosure is illustrative including words of description rather than of limitation. Many modifications and variations of the present disclosure are possible in light of the above teachings, and the disclosure may be practiced otherwise than as specifically described herein.

What is claimed is:

1. An insulating member for covering a conduit in a clean room, said insulating member having a length and defining a cavity extending along the length, wherein said cavity is sized and shaped to receive the conduit and wherein said insulating member comprises:
an innermost layer that is a closed cell fluoropolymer foam and is disposed to contact the conduit; and
an outermost layer that is disposed on said innermost layer and that is a second fluoropolymer.

2. The insulating member of claim 1 wherein said closed cell fluoropolymer foam is polyvinylidene fluoride closed cell foam.

3. The insulating member of claim 2 wherein said second fluoropolymer is polyvinylidene fluoride resin.

4. The insulating member of claim 3 wherein said outermost layer has a thickness of 0.002 inches to 0.060 inches and wherein said innermost layer has a thickness of 0.12 inches to 3.0 inches.

5. The insulating member of claim 4 wherein said outermost layer is disposed on and in direct contact with said innermost layer and said insulating member is free of any adhesive or tie layer disposed between said innermost layer and said outermost layer.

6. The insulating member of claim 4 further comprising an adhesive disposed between said innermost layer and said outermost layer.

7. The insulating member of claim 6 wherein said adhesive is a polyurethane hotmelt adhesive.

8. An insulating member for covering a conduit in a clean room, said insulating member having a length and defining a cavity extending along the length, wherein said cavity is sized and shaped to receive the conduit and wherein said insulating member comprises:
an innermost layer that is a closed cell fluoropolymer foam and is disposed to contact the conduit; and
an outermost layer that is disposed on said innermost layer and that is an organic polymer.

9. The insulating member of claim 8 wherein said organic polymer is chosen from polyethylene, polypropylene, and nylon.

10. The insulating member of claim 9 wherein said closed cell fluoropolymer foam is a polyvinylidene fluoride closed cell foam.

11. The insulating member of claim 10 wherein said outermost layer has a thickness of 0.002 inches to 0.060 inches and wherein said innermost layer has a thickness of 0.12 inches to 3.0 inches.

12. The insulating member of claim 11 wherein said outermost layer is disposed on and in direct contact with said innermost layer and said insulating member is free of any adhesive or tie layer disposed between said innermost layer and said outermost layer.

13. The insulating member of claim 11 further comprising an adhesive disposed between said innermost layer and said outermost layer.

14. The insulating member of claim 13 wherein said adhesive is a polyurethane hotmelt adhesive.

15. An insulating member for covering a conduit in a clean room, said insulating member comprising:
an innermost layer that comprises a fluoropolymer foam; and
an outermost layer that is disposed on and in direct contact with said innermost layer and that comprises a polymer chosen from an organic polymer and a second fluoropolymer.

16. The insulating member of claim 15 wherein said polymer is chosen from polyethylene, polypropylene, nylon, and polyvinylidene fluoride.

17. The insulating member of claim 16 wherein said fluoropolymer foam is a polyvinylidene fluoride closed cell foam.

18. The insulating member of claim 17 wherein said outermost layer has a thickness of 0.002 inches to 0.060 inches and wherein said innermost layer has a thickness of 0.12 inches to 3.0 inches.

19. The insulating member of claim 18 wherein said outermost layer is disposed on and in direct contact with said innermost layer and said insulating member is free of any adhesive or tie layer disposed between said innermost layer and said outermost layer.

20. The insulating member of claim 18 further comprising an adhesive disposed between said innermost layer and said outermost layer, wherein said adhesive is a polyurethane hot melt adhesive.
